(19) United States
(12) Patent Application Publication
(10) Pub. No.: US 2016/0347437 A1
(43) Pub. Date: Dec. 1, 2016

(54) STRUCTURE TO SUPPORT EQUIPMENT IN A FUSELAGE OF AN AIRCRAFT

(71) Applicant: Airbus Operations Limited, Bristol (GB)

(72) Inventors: Dmitriy MAMUSHKIN, Moscow (RU); Ivan BESPALOV, Dimitrovgrad (RU)

(21) Appl. No.: 15/167,457

(22) Filed: May 27, 2016

(30) Foreign Application Priority Data
May 28, 2015 (RU) 2015120324

(51) Int. Cl. B64C 1/06

(52) U.S. Cl. CPC B64C 1/061

(57) ABSTRACT

A structure for fastening components of interior equipment in the passenger compartment of an airplane. The fastening structure contains a fastener produced on the fuselage; suspension elements (2) immovably connected to the fastener, and at least one system support (1) running in the longitudinal direction of the fuselage, connected to the suspension elements (2). The suspension elements (2) include at least one first suspension element (9) and at least one second suspension element (10, 11), wherein each of the first suspension elements is rigidly connected to the system support, and each of the second suspension elements forms with the system support a sliding connection, so that the system support is able to slide relative to these second suspension elements along the longitudinal axis of the airplane fuselage. The sliding capability of the system support relative to the second suspension elements substantially reduces the load on the bulkhead in the longitudinal direction.

### RELATED APPLICATION

This application claims the benefit of Russian Patent Application No. 2015120324 filed May 28, 2015, wherein the entire contents of this application is hereby incorporated by reference.

### BACKGROUND OF INVENTION

The invention on the whole pertains to the installing of equipment on an airplane. In particular, the invention relates to a structure for fastening components of interior equipment in the passenger compartment, e.g., fuselage, of an airplane, which structure can be used aboard aircraft of different modifications.

Interior equipment, especially components of the electrical system and the air conditioning system in passenger compartments of an airplane, are generally secured above the ceiling area of the passenger compartment.

For example, application US 2011/0233336 A1 describes a structure for fastening of equipment components in the passenger compartment of an airplane, containing brackets which connect the bulkheads to the stringers of the fuselage framework, and a system support fastened to these brackets in the form of a strip with a plurality of openings arranged uniformly along its length for connection to the components of the interior equipment.

In such a structure, the fastening must be individually matched up with the desired compartment configuration, so that such a fastening of components of the interior equipment results in relatively inflexible (not allowing for changes) compartment configurations. Any change in the compartment configuration makes it necessary to replace a large number of fastening components. Moreover, major changes in the compartment configuration can only be performed at special workplaces having a corresponding permit, which results in significant financial expenses and lengthy delays when changing the compartment configuration.

Prior art material to the present invention is the structure for fastening of components of the interior equipment in the passenger compartment of an airplane according to patent RU 2433066 C2, containing at least one system support running in the longitudinal direction of the fuselage and formed from several consecutively connected segments, and a means of suspension for connecting the system support to the elements of the fuselage framework, said system support having a plurality of fastening elements uniformly disposed along its length for connection to the components of the interior equipment.

Such a structure makes it possible to secure components of the interior equipment in the passenger compartment with greater flexibility of configuration as compared to the above-described structure. However, this structure also has drawbacks including:

(i) on account of increased displacements of the fuselage, loads in the direction of the system support are transmitted not only to the skin, but also to the bulkheads, which is undesirable for the fuselage structure; and

(ii) the structure of the system support contains a single closed circuit of segments, which may result in difficulties in assembling the structure in certain places due to accumulation of tolerances (during fabrication, assembly, and so on).

### SUMMARY OF THE INVENTION

A problem which the invention proposes to solve is to create a structure for fastening the components of interior equipment in the passenger compartment of an airplane which lacks the indicated drawbacks or at least reduces their influence.

This problem is solved in a prefabricated structure for fastening the components of equipment inside an airplane fuselage, containing fastening means produced on the fuselage; suspension elements immovably connected to said fastening means, and at least one system support running in the longitudinal direction of the fuselage, connected to the suspension elements.

According to an embodiment of the invention, the suspension elements include at least one first suspension element and at least one second suspension element, wherein each of the first suspension elements is rigidly connected to the system support, and each of the second suspension elements forms with the system support a sliding connection, so that the system support is able to slide relative to these second elements along the longitudinal axis of the airplane fuselage.

In such an embodiment, the system support has the capability of axial sliding with respect to certain (second) suspension elements, which significantly decreases the axial loads transmitted from the system support to the bulkheads.

The system support may be formed from several sequentially connected segments. At least two segments of the system support are joined together by means of a sliding connection, while the connections of the other segments of the system support are rigid. As a result, the unified chain of segments of the system support is broken up into smaller sections, joined together by means of the sliding connection, which makes it possible to join together two adjacent segments of the system support with the possibility of adjusting their relative position and thereby compensate for tolerances occurring during the fabrication of the parts and during their assembly, as well as the deformation of the fuselage.

At the locations of the sliding connections of the segments of the system support, one of these segments may be connected to the first suspension element, while in the other locations the system support is connected to the second suspension elements.

The system support can be made in the form of a series of connected segments, each having a U-shape in cross section.

Furthermore, each of the first suspension elements includes a first bracket, one end of which is rigidly connected to a corresponding fastening means produced on the fuselage, while the other end contains two sections, one of which is situated between the flanges of one segment and rigidly connected to these flanges by means of fastening means, while the other of these sections is situated between the flanges of the other segment and has a slot produced in it, through which passes a bolt likewise passing through corresponding openings in the flanges of said other segment.

To reduce friction in each of said sliding connections, a plastic sleeve can be arranged in the slot of the first bracket, through which the bolt passes.

This sleeve can be made of two parts, separated from each other along the axis of the bolt, while between the bolt and the plastic sleeve is arranged a rigid sleeve, the length of which is essentially equal to the distance between the outer surfaces of the flanges of the segment.

Each rigid connection of the segments can be formed by means of two plates, each of which is fastened to corresponding flanges of abutting segments, and in each of which longitudinal slots are made, wherein each of the suspension means in the locations of the rigid connections of the segments includes a second bracket, one end of which is rigidly connected to a corresponding element of the fuselage framework, while the other end contains a section situated between said plates, and in this section there is produced an opening through which passes a bolt, likewise passing through corresponding slots in the plates.

In order to reduce friction, a rigid sleeve can be seated on the bolt, the length of which exceeds the distance between the outer surfaces of said two plates, and one plastic sleeve each is placed in the slots of these two plates, through which passes the bolt with the rigid sleeve seated thereon.

The second suspension elements may include third brackets, one end of each being rigidly connected to corresponding fastening means produced on the fuselage, while the other end contains a section situated between the flanges of the corresponding segment, and in this section there is produced a slot through which passes the bolt likewise, passing through corresponding openings in the flanges of said segment.

A plastic sleeve can likewise be arranged in the slot of each of the third brackets, through which passes the bolt.

This sleeve can likewise consist of two parts, separated from each other along the axis of the bolt, while between the bolt and the plastic sleeve is arranged a rigid sleeve, the length of which is essentially equal to the distance between the outer surfaces of the flanges of the segment.

The prefabricated structure for fastening equipment components inside an airplane fuselage can contain at least one pair of parallel-arranged system supports, in particular, two pairs of parallel-arranged system supports, said pairs of system supports being arranged symmetrically with respect to the longitudinal vertical plane of symmetry of the airplane.

The system support in each of the pairs are joined together by means of fittings, which are in turn connected by tie rods to elements of the fuselage framework, each fitting being disposed between parallel segments, the flanges of which are rigidly connected to corresponding sections of the first brackets, while the tie rod is connected by one end to this fitting, and by the other end it is connected to the element of the fuselage framework to which the first bracket is rigidly connected.

### SUMMARY OF THE DRAWINGS

These and other features and advantages of the invention will become clearer from the following detailed description with references to the drawings.

FIG. 1 shows a fragment of a prefabricated structure for fastening of equipment components inside the fuselage of an airplane according to the invention, perspective view;

FIG. 2 shows a first bracket as shown in circle A of FIG. 1;

FIG. 3 is a side view of the first bracket;

FIG. 4 shows the first bracket in a cross section taken along D-D in FIG. 3;

FIG. 5 is a perspective view shows the first bracket separately;

FIG. 6 shows a second bracket as shown in circle B in FIG. 1;

FIG. 7 is a side view of the second bracket;

FIG. 8 shows the second bracket in cross section along E-E in FIG. 7;

FIG. 9 is a perspective view of the second bracket shown separately;

FIG. 10 shows a third bracket as shown in circle C in FIG. 1;

FIG. 11 is a side view of the third bracket;

FIG. 12 shows the third bracket in cross section along F-F in FIG. 11;

FIG. 13 is a perspective view of the third bracket shown separately.

### DETAILED DESCRIPTION OF AN EMBODIMENT(S) OF INVENTION

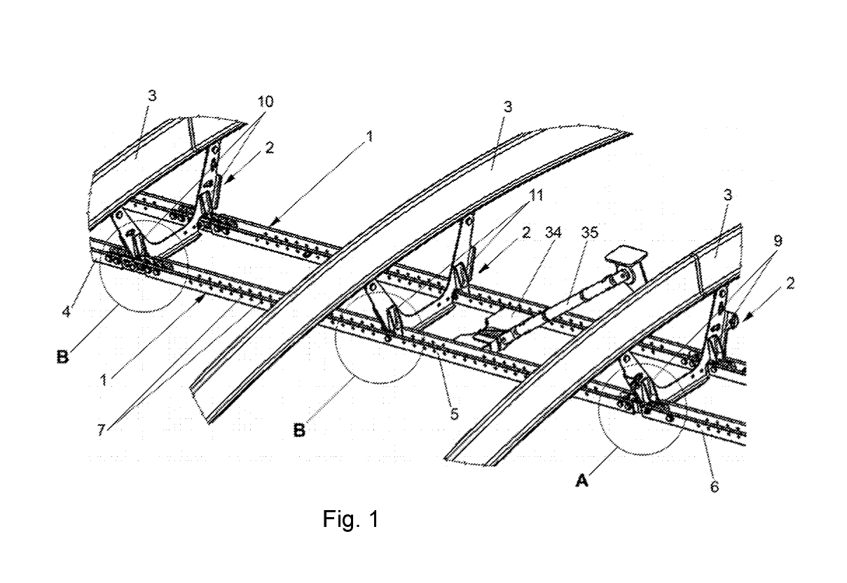

To facilitate understanding, FIG. 1 conventionally does not show the skin or the longitudinal composition of the fuselage framework.

As is shown in FIG. 1, the fastening structure according to one possible variant embodiment of the invention contains at least one pair of system supports 1, running in the longitudinal direction of the fuselage, and suspension elements 2 connecting the system supports 1 to elements of the fuselage framework, especially to the bulkheads 3.

Each of the system supports 1, e.g., channels, is formed from several sequentially connected segments, having a U-shape in cross section. FIG. 1 shows a segment, e.g., channel segment, of the structure with three such segments, 4, 5 and 6 in each of the system supports. On each of the segments 4, 5 and 6 there is a plurality of fastening elements uniformly disposed along its length, for example in the form of openings 7. The segments of each of the system supports are joined consecutively to an alternating sliding connection and at least one rigid connection. For example, the connections of the segments in each of the system supports 1 can be arranged in the following sequence: “ . . . -rigid-sliding-rigid-sliding- . . . ”, or “. . . -rigid-rigid-sliding-rigid-rigid-sliding- . . . ”, or “ . . . -rigid-rigid-rigid-sliding-rigid-rigid-rigid-sliding- . . . ”. The number of rigidly connected segments between two adjacent sliding connections is chosen from the specific structure features of the fuselage framework.

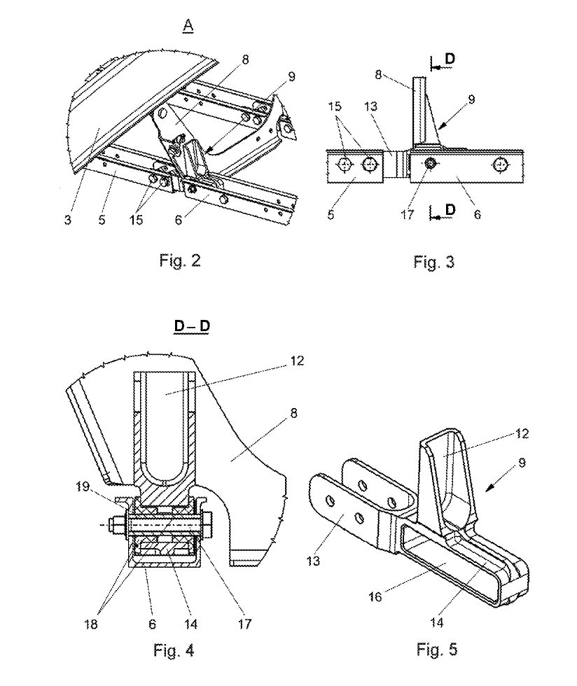

Each of the suspension elements 2 includes a main bracket 8 (FIG. 2), fastened to a corresponding bulkhead 3, and two each of first, second or third brackets 9, 10 and 11, each of which is connected rigidly by one end to the main bracket 8, and by the other end it is joined to the corresponding system support 1. The first bracket 9 is disposed in location A of the sliding connection of segments 5 and 6, the second bracket 10 at location B of the rigid connection of segments 4 and 5, and the third bracket 11 at location C between the abutments of the segments in the zone of transverse connection of the segments of the two system supports.

FIGS. 2 to 4 show the first bracket 9 at location A (FIG. 1) of the sliding connection of the segments, and FIG. 5 shows the first bracket separately, used to produce this connection.

The first bracket 9 has one end 12 which is rigidly connected to the main bracket 8 and a second end, containing two sections 13 and 14 of the first bracket. Section 13 is disposed between the flanges of the segment 5 and rigidly connected to these flanges by means of fastening means 15, e.g., a threaded bolt and nut, screw, rivet, pin or other such fastener. Section 14 is disposed between the flanges of the other segment 6 and has a slot 16 produced therein, through which passes a bolt 17, likewise passing through corresponding openings in the flanges of the segment 6. The bolt 17 may include a head with annular flange or washer, a smooth surface cylindrical shaft extending from the head and a threaded end of the shaft to receive a nut and a washer. In the slot 16 is arranged a plastic sleeve 18, comprising two parts, separated from each other along the axis of the bolt 17, while between the bolt 17 and the plastic sleeve 18, e.g., deformable sleeve, is arranged a rigid sleeve 19, made of aluminum, for example. The length of the rigid sleeve 19 is essentially equal to the distance between the outer surfaces of the flanges of the segment 6. The plastic sleeve 19 ensures a sliding of the segment 6 along the slot 16, while the rigid sleeve 19 prevents excessive compression of the segment 6 when tightening the bolt 17 by a corresponding nut.

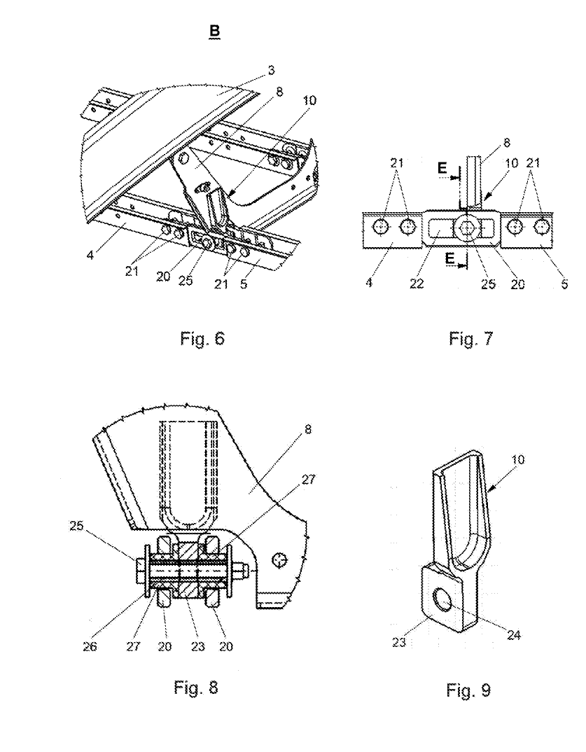

FIGS. 6 to 8 show the second bracket 10 at location B (FIG. 1) of the rigid connection of the segments, while FIG. 9 shows the second bracket separately, which is situated at this location.

Each rigid connection of the segments 4 and 5 is formed by means of two plates 20, each of which is secured by means of fastening means 21, e.g., a threaded bolt and nut, screw, rivet, pin or other such fastener, to the corresponding flanges of abutting segments 4 and 5. There are longitudinal slots 22 produced in each of the plates 20. Between the plates is disposed a section 23 of the second bracket 10 which has one end rigidly connected to the main bracket 8, and at the other end is disposed the said section 23. In this section 23 there is produced an opening 24, through which passes a bolt 25, likewise passing through corresponding slots 22 in the plates.

The bolt 25 may include a head with annular flange or washer, a smooth surface cylindrical shaft extending from the head and a threaded end of the shaft to receive a nut and a washer. On the bolt 25 is seated a rigid sleeve 26, the length of which exceeds the distance between the outer surfaces of the two plates 20, while in the slots 22 of these two plates are installed a plastic sleeve 27, e.g., deformable, for each, through which passes the bolt 25 with rigid sleeve 26 seated thereon.

The plastic sleeves 27 enable a sliding of the second bracket 10 along the slots 22, while the rigid sleeve 26 prevents excessive compression of the plastic sleeves 27 when tightening the bolt 25 by a corresponding nut.

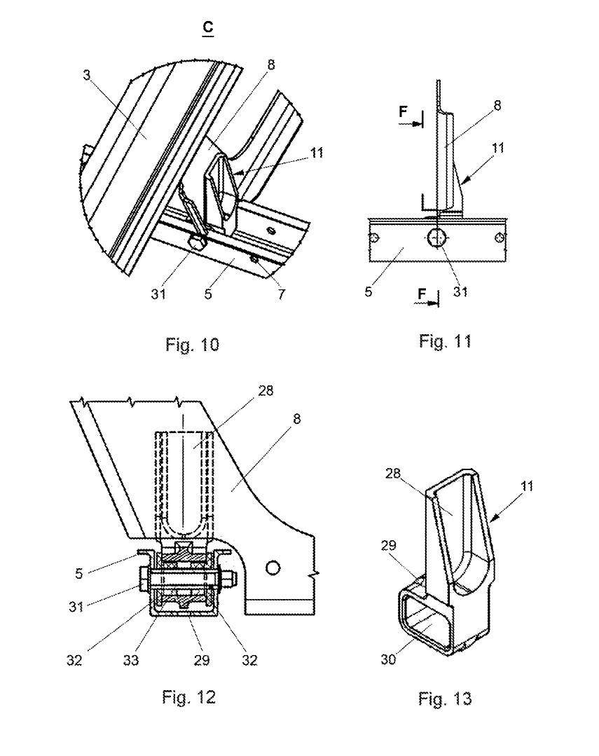

FIGS. 10 to 12 show the location of the third bracket that connects the segments of the system support to the bulkhead at site C (FIG. 1) between the abutments in the zone of transverse connection of the segments of the two system supports, while FIG. 13 shows the third bracket separately, situated in this location.

The third bracket 11 has one end 28 rigidly connected to the main bracket 8, and the other end containing the section 29, situated between the flanges (sidewalls of the channel) of the U-shaped cross section of segment 5. In section 29 of the bracket 11 there is produced a slot 30, through which passes the bolt 31, likewise passing through corresponding openings in the flanges of the segment 5. The bolt 31 may include a head with annular flange or washer, a smooth surface cylindrical shaft extending from the head and a threaded end of the shaft to receive a nut and a washer.

In the slot 30 is arranged a plastic sleeve 32, consisting of two parts, separated from each other along the axis of the bolt 31, while between the bolt 31 and the plastic sleeve 32, deformable sleeve, is arranged a rigid sleeve 33, made of aluminium, for example. The length of the sleeve 33 is essentially equal to the distance between the outer surfaces of the flanges of the segment 5. The plastic sleeve 32 ensures a sliding of the bracket 8 along the segment 5, while the rigid sleeve 33 prevents excessive compression of the segment 5 when tightening the bolt 31 by a corresponding nut.

The suspension elements 2, including the main brackets 8 attached to the bulkheads 3, and the first, second and third brackets 9, 10 and 11, connecting the main brackets to the system supports 1, transmit to the bulkheads the load in the plane perpendicular to the longitudinal direction of the system supports.

For the transmission to the aircraft skin of the load in the longitudinal direction, the system supports 1 in each of their pairs are joined together by means of fittings 34 (FIG. 1), which are connected in turn by tie rods 35 to framework elements of the fuselage, in particular, the bulkheads 3 and the skin (not shown). Each fitting 34 is disposed between parallel segments 5, the flanges of which are rigidly connected to corresponding sections 13 of the first brackets 9. The tie rod 35 is connected by one end to this fitting 34, and by the other end it is connected to the bulkhead 3 to which the first bracket 9 is rigidly connected.

The fastening structure can contain, in particular, two pairs of parallel-arranged system supports (not shown in the drawings), preferably disposed symmetrically in regard to the longitudinal vertical plane of symmetry of the airplane.

The structure for the fastening of components of interior equipment in the passenger compartment of an airplane according to the invention affords the possibility of connecting two neighbouring segments together with the possibility of regulating their relative position, which makes it possible to compensate for tolerances during the fabrication of parts, during assembly, and so forth, and to compensate for deformation of the fuselage. Furthermore, the sliding connection of the second and third brackets to the system support allows the main brackets, connected to these brackets, to move relative to the segments of the system support, which substantially decreases the load on the bulkhead in the longitudinal direction.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise.

The invention is:

1. A prefabricated structure for fastening the components of equipment inside an airplane fuselage, comprising:
an element integral with the fuselage;
suspension elements immovably connected to the element integral with the fuselage, and
at least one system support running in the longitudinal direction of the fuselage, connected to the suspension elements,
wherein the suspension elements include at least one first suspension element and at least one second suspension element,
wherein each of the first suspension elements is rigidly connected to the system support, and each of the second suspension elements forms with the system support a sliding connection, so that the system support is able to slide relative to the second suspension elements along the longitudinal direction.

2. The structure according to claim 1, wherein the system support is formed from connected segments.

3. The structure according to claim 2, further comprising at least two segments of the system support joined together by a sliding connection, while the connections between other segments of the system are rigid connections.

4. The structure according to claim 3, wherein at the locations of the sliding connections of the segments of the system support, one of the segments is connected to the first suspension element, while at another of the locations the system support is connected to the second suspension elements.

5. The structure according to claim 4, wherein each segment of the system support is made is a channel having a U-shape in cross section.

6. The structure according to claim 5, wherein each of the first suspension elements includes a first bracket, one end of which is rigidly connected to the element of or one the fuselage and another end includes two sections, one of which sections is situated between flanges of one of the segments and is rigidly connected to the flanges by a fastener, while another of the two sections is situated between flanges of another of the segments and has a slot through which passes a bolt which passes through corresponding openings in the flanges of the another segment.

7. The structure according to claim 6, further comprising a plastic sleeve arranged in the slot of the first bracket.

8. The structure according to claim 7, wherein the sleeve comprises two parts, separated from each other along an axis of the bolt, while between the bolt and the plastic sleeve is arranged a rigid sleeve, the length of which rigid sleeve is equal to a distance between outer surfaces of the flanges of the segment.

9. The structure according to claim 5, wherein each rigid connection of the segments is formed by two plates, each of which is fastened to corresponding flanges of abutting segments, and in each of the two plates are a longitudinal slot,
wherein the system support in the locations of the rigid connections of the segments is connected to the second suspension element, which includes a second bracket having one end rigidly connected to the element of or on the fuselage and another end including a section between the two plates, and wherein an opening through which passes a bolt, likewise passing through corresponding slots in the plates.

10. The structure according to claim 9, further comprising a rigid sleeve seated on the bolt, the length of which rigid sleeve exceeds a distance between outer surfaces of said two plates, and a plastic sleeve in the slots of the two plates, through which plastic sleeve passes the bolt with the rigid sleeve seated thereon.

11. The structure according to claim 5, wherein the second suspension elements include third brackets, one end of each being rigidly connected to corresponding fastening means produced on the fuselage, while the other end contains a section situated between the flanges of the corresponding segment, and wherein in this section there is produced a slot through which passes the bolt, likewise passing through corresponding openings in the flanges of said segment.

12. The structure according to claim 11, further comprising that a plastic sleeve is arranged in the slot of every third bracket, through which the bolt passes.

13. The structure according to claim 12, wherein the sleeve consists of two parts, separated from each other along the axis of the bolt, while between the bolt and the plastic sleeve is arranged a rigid sleeve, the length of which is essentially equal to the distance between the outer surfaces of the flanges of the segment.

14. The structure according to claim 1, further comprising at least one pair of parallel-arranged system supports.

15. The structure according to claim 14, further comprising two pairs of parallel-arranged system supports, said pairs of system supports being arranged symmetrically with respect to the longitudinal vertical plane of symmetry of the airplane.

16. The structure according to claim 14, wherein the system supports in each of the pairs are joined together by means of fittings, each fitting being disposed between parallel segments, the flanges of which are rigidly connected to corresponding sections of the first brackets, and connected by tie rods to elements of the fuselage, the tie rod being connected to the element of the fuselage framework on which is produced the fastening means which is rigidly connected to one end of the first bracket.

17. An assembly configured to support equipment components within an airplane fuselage, the assembly comprising:
first and second suspension elements fixed to the fuselage and extending into the fuselage;
a system support supported by the first and second suspension elements, wherein the system support includes a series of suspension elements extending along a portion of the length of the fuselage,
wherein the first suspension element is connected to one of the suspension elements by a fixed connection which fixes the first suspension element at a point of contact on the suspension elements, and
wherein the second suspension element is connected to another one of the suspension elements by a sliding connection, wherein the sliding connection includes a slot and a bolt which slides in the slot which allows the second suspension element to slide a length of the slot with respect to the another one of the suspension elements, and the slot is fixed to one of the second suspension element and the another one of the suspension elements and the bolt is fixed to the other one of the second suspension element and the another one of the suspension elements.

18. The assembly of claim 17 wherein the sliding connection includes a plastic sleeve between the slot and the bolt.

19. The assembly of claim 18 wherein the sliding connection includes a metal sleeve between the slot and the plastic sleeve.

20. The assembly of claim 17 wherein the sliding connection is between the another one of the suspension elements and third one of the suspension elements.
